(19) United States
(12) Patent Application Publication
(10) Pub. No.: US 2008/0149204 A1
(43) Pub. Date: Jun. 26, 2008

(54) PISTON VALVE

(75) Inventor: Hiroyuki SHIMAI, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/953,304

(22) Filed: Dec. 10, 2007

(30) Foreign Application Priority Data
Dec. 20, 2006 (JP) 2006-343505

(51) Int. Cl. F16K 11/07

(52) U.S. Cl. 137/625.48

(57) ABSTRACT

A piston valve includes a body having an inlet on one end side of the body, a relief hole that opens on a sidewall of the body, a piston slidably inserted in the body, a damper chamber formed in the body, and a spring disposed in the chamber and urging the piston toward the inlet. Controlled fluid flows into the body through the inlet, and is discharged through the relief hole. The piston is located between the inlet and the chamber in the longitudinal direction. An opening area of the relief hole is varied according to a position of the piston, in which the piston is balanced when pressure of controlled fluid applied to an inlet side-surface of the piston is equal to a sum of internal pressure of the chamber and reaction force of the spring, the sum being applied to a chamber side-surface of the piston.

### CROSS REFERENCE TO RELATED APPLICATION

This application is based on and incorporates herein by reference Japanese Patent Application No. 2006-343505 filed on Dec. 20, 2006.

### BACKGROUND OF THE INVENTION

1. Field of the Invention

The present invention relates to a piston valve.

2. Description of Related Art

As described in JP2000-240531A (corresponding to U.S. Pat. No. 6,289,875), a piston valve is used as, for example, a pressure-regulating valve for a fuel injection pump.

As shown in FIG. 12, the piston valve includes a body 100, a plug 110, a piston 120, and a spring 140. A cylindrical hole passes through the body 100. The plug 110 blocks a right end of the cylindrical hole. The piston 120 is slidably inserted into the cylindrical hole. The spring 140 is disposed in a space (damper chamber 130) formed between the piston 120 and the plug 110, and urges the piston 120.

A cylindrical bush 150 is attached to an end of the cylindrical hole formed in the body 100 on its opposite-to the plug 110 side (left end in FIG. 12). The bush 150 defines an inlet, through which controlled fluid flows in, and serves as a piston seating surface, on which the piston 120 urged by the spring 140 is pressed. The bush 150 also prevents the piston 120 and the spring 140 from falling out of the cylindrical hole.

A relief hole 160, through which controlled fluid flows out, and a breathing hole 170, which communicates with the damper chamber 130, are formed on a sidewall of the body 100.

The plug 110 serves as a spring seating surface, which supports an end portion of the spring 140 on its opposite-to the piston 120 side, and adjusts valve opening pressure of the piston valve (initial load of the spring 140) using its attaching depth with respect to the cylindrical hole.

The piston 120 is balanced in a position, in which pressure of controlled fluid applied to a front surface (left end face in FIG. 12) of the piston 120 is equal to the sum of internal pressure of the damper chamber 130 applied to a back face (right end face in FIG. 12) of the piston 120 and reaction force of the spring 140. The pressure of controlled fluid is adjusted according to a valve opening position (position in which the relief hole 160 is opened) of the piston 120.

In the above piston valve, when pressure of controlled fluid behaves anomalously, for example, when the pressure is abnormally high or repeatedly fluctuates sharply, an amplitude of the piston 120 becomes large. Accordingly, the spring 140 may have permanent strain, or may be damaged. Furthermore, when the piston 120 having large kinetic energy indirectly collides with the plug 110 with the spring 140 totally compressed, the plug 110 may fall out of the body 100.

In a piston valve shown in FIG. 13, the right end of the cylindrical hole is blocked in a pocketed hole shape by a bottom wall portion 180 provided integrally with the body 100. In this piston valve, the plug 110 in FIG. 12 does not need to be used, so that a problem that the plug 110 falls out of the body 100 is not caused even when pressure of controlled fluid behaves anomalously.

Moreover, in a piston valve shown in FIG. 14, a stopper pin 190 for preventing overshoot of the piston 120 is provided inside the spring 140. In the piston valve, when the piston 120 is displaced in a direction in which the relief hole 160 is opened (rightward in FIG. 14), the spring 140 is not totally compressed due to excessive displacement of the piston 120. Accordingly, permanent strain or breakage failure of the spring 140 is prevented.

However, in the piston valve shown in FIGS. 13, 14, the cylindrical hole formed in the body 100 is not a through hole but is blocked in a pocketed hole shape. Thus, a piston sliding surface is not easily formed with high precision.

Since the plug 110 is not used, the valve opening pressure needs to be adjusted by selectively using the spring 140 (a spring best suited for the valve opening pressure is selected and used), or by selecting thickness of a shim 200, which serves as the spring seating surface, and the number of shims 200. Accordingly, it takes extra effort to assemble the piston valve. Furthermore, when the shim 200 or stopper pin 190 is used, the number of parts increases.

### SUMMARY OF THE INVENTION

The present invention addresses the above disadvantages. Thus, it is an objective of the present invention to provide a piston valve, in which a piston sliding surface is easily formed with high precision, and which ensures improved reliability.

To achieve the objective of the present invention, there is provided a piston valve including a body, a relief hole, a piston, a damper chamber, and a spring. The body has an inlet on one end side of the body in a longitudinal direction of the body. Controlled fluid flows into the body through the inlet. The relief hole opens on a sidewall of the body. Controlled fluid in the body is discharged through the relief hole. The piston is slidably inserted in the body. The damper chamber is formed in the body. The piston is located between the inlet and the damper chamber in the longitudinal direction. The spring is disposed in the damper chamber and urges the piston in a direction toward the inlet. An opening area of the relief hole is varied according to a position of the piston, in which the piston is balanced when pressure of controlled fluid applied to an inlet side-surface of the piston is equal to a sum of internal pressure of the damper chamber and reaction force of the spring, the sum being applied to a damper chamber side-surface of the piston. The body is divided into a first body and a second body. The first body has a cylindrical shape and opens at both ends of the first body. The piston is slidably held in a piston sliding hole, which is formed on an inner circumferential side of the first body. The second body is combined with the first body such that the second body is joined to a portion of the first body located on an opposite side of the inlet. The second body has a cylindrical hole, which defines the damper chamber in the body when the second body is combined with the first body.

### BRIEF DESCRIPTION OF THE DRAWINGS

The invention, together with additional objectives, features and advantages thereof, will be best understood from the following description, the appended claims and the accompanying drawings in which:

FIG. 1 is a sectional view showing a piston valve according to a first embodiment of the present invention;

FIG. 2 is a sectional view showing the piston valve according to the first embodiment;

FIG. 3 is a sectional view showing a piston valve according to the first embodiment;

FIG. 4 is a sectional view showing a piston valve according to the first embodiment;

FIG. 5 is a sectional view showing a piston valve according to a second embodiment of the present invention;

FIG. 6 is a sectional view showing a piston valve according to the second embodiment;

FIG. 7 is a sectional view showing a piston valve according to the second embodiment;

FIG. 8 is a sectional view showing a piston valve according to a third embodiment of the present invention;

FIG. 9 is a sectional view showing a piston valve according to a fourth embodiment of the present invention;

FIG. 10 is a sectional view showing a piston valve according to the fourth embodiment;

FIG. 11 is a sectional view showing a piston valve according to the fourth embodiment;

FIG. 12 is a sectional view showing a previously proposed piston valve;

FIG. 13 is a sectional view showing a previously proposed piston valve; and

FIG. 14 is a sectional view showing a previously proposed piston valve.

### DETAILED DESCRIPTION OF THE INVENTION

The present invention is described in detail using the following embodiments.

### First Embodiment

A piston valve 1 of a first embodiment of the present invention is used, for example, as a pressure-regulating valve of a feed pump (not shown), which is incorporated in a fuel injection pump for a diesel engine. The feed pump pumps up fuel from a fuel tank to discharge it into a fuel supply pump. The piston valve 1 (pressure-regulating valve) regulates pressure of fuel discharged from the feed pump.

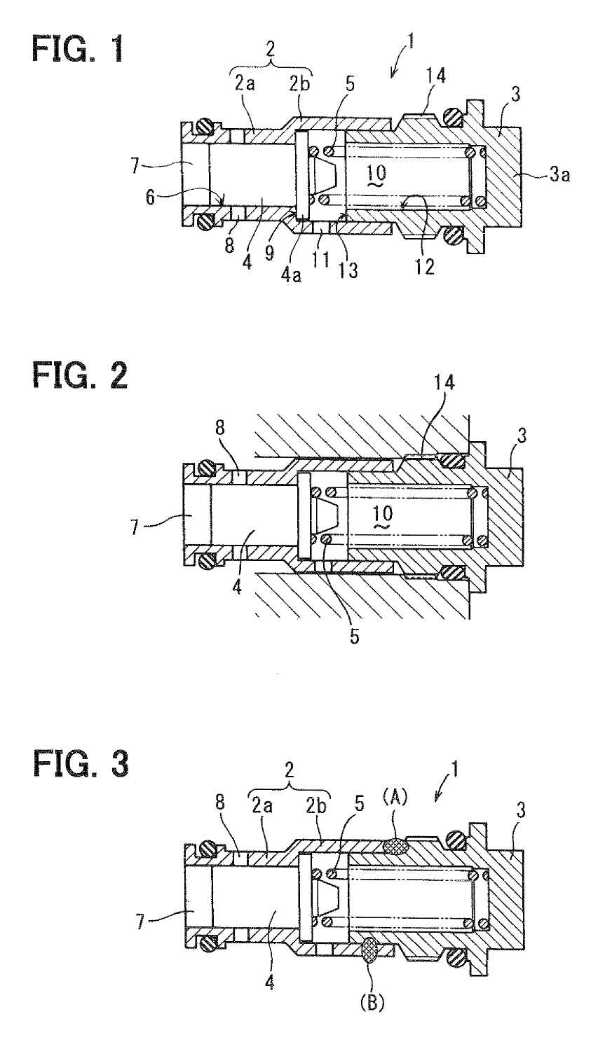

As shown in FIG. 1, the piston valve 1 includes a cylindrically-shaped body (a first body 2 and a second body 3), a piston 4, and a spring 5. The piston 4 is received in the body. The spring 5 urges the piston 4 against pressure of controlled fluid (fuel discharged from the feed pump) flowing into the body.

The body is divided between the first body 2 and the second body 3.

The first body 2 has a cylindrical shape, which opens on its both ends. The first body 2 has a piston sliding portion 2a on one end side of a generally central portion of the first body 2 in its longitudinal direction, and a large diameter cylindrical portion 2b on the other end side of the central portion.

The piston sliding portion 2a has a sliding hole 6 (piston sliding hole), which slidably holds the piston 4, on its inner circumferential side. Controlled fluid flows into the sliding hole 6 through an inlet 7, which is an opening of the piston sliding portion 2a on its one end side. A relief hole 8, which communicates with the sliding hole 6, is formed on a sidewall of the piston sliding portion 2a.

The large diameter cylindrical portion 2b has a larger inner diameter than that of the sliding hole 6. A step, which serves as a valve closed side seating surface 9 of the piston 4, is provided between an inner circumferential surface of the sliding hole 6 and an inner circumferential surface of the large diameter cylindrical portion 2b.

A breathing hole 11, which communicates with a damper chamber 10, is formed on a sidewall of the large diameter cylindrical portion 2b. The damper chamber 10 is a space formed on an opposite-to the inlet 7 side of the piston 4 in the body. The damper chamber 10 is filled with controlled fluid (fuel) flowing in through the breathing hole 11.

The second body 3 has a cylindrical hole 12, which receives the spring 5, on its inner circumferential side. A bottom wall portion 3a, which is formed integrally with the second body 3, blocks a right end of the cylindrical hole 12 in FIG. 1 in a pocketed hole shape.

The cylindrical hole 12 has generally the same inner diameter as that of the sliding hole 6 formed in the piston sliding portion 2a. One end side (an opposite-to the bottom wall portion 3a side) of the second body 3 in its longitudinal direction, on which the cylindrical hole 12 opens, is fitted into the inner circumferential surface of the large diameter cylindrical portion 2b of the first body 2. An end face of the second body 3 on the one end side serves as a stopper 13, which prevents an overshoot of the piston 4. The stopper 13 is formed with a predetermined distance away from the step (valve closed side seating surface 9) formed in the first body 2 in a longitudinal direction of the body (a horizontal direction in FIG. 1). That is, the predetermined distance is kept between the valve closed side seating surface 9 of the piston 4 and the stopper 13.

As shown in FIG. 2, the second body 3 has a fixing portion 14 (e.g., a male thread portion) for fixing the piston valve 1 to another object (e.g., a housing of the fuel supply pump).

The piston 4 is slidably inserted into the sliding hole 6 of the piston sliding portion 2a, and has a flange portion 4a projecting radially outward at an end portion of the piston 4 on its opposite-to the inlet 7 side. The flange portion 4a is provided such that it can be moved between the valve closed side seating surface 9 and the stopper 13. Accordingly, when the piston 4 is moved in a direction (valve opening direction) in which the relief hole 8 is opened (moved toward a right side in FIG, 1), the flange portion 4a contacts the stopper 13 and thereby displacement of the piston 4 in the valve opening direction is restricted. When the piston 4 is moved in a direction (valve closing direction) in which the relief hole 8 is closed, the flange portion 4a contacts the valve closed side seating surface 9 and thereby displacement of the piston 4 in the valve closing direction is restricted.

The spring 5 is received in the cylindrical hole 12 formed in the second body 3, and urges the piston 4 in a direction toward the inlet 7. As shown in FIG. 1, the flange portion 4a of the piston 4 urged by the spring 5 contacts the valve closed side seating surface 9 in a static condition in which pressure of controlled fluid is not applied to the piston 4.

Workings and effects of the piston valve 1 are described below.

The piston 4 is balanced in a position in which pressure (discharge pressure of the feed pump) of controlled fluid flowing in through the inlet 7 is equal to the sum of internal pressure of the damper chamber 10 and reaction force of the spring 5. The pressure of controlled fluid is kept at a predetermined value according to a valve opening position (position in which the relief hole 8 is opened) of the piston 4.

In the piston valve 1, the body that receives the piston 4 and the spring 5 is divided into the first body 2 and the second body 3, and the first body 2, in which the sliding hole 6 is formed, has a cylindrical shape. By virtue of the above configuration, the sliding hole 6 is formed not in a pocketed hole shape but as a through hole, and thereby the sliding hole 6 is easily formed with high precision.

Since the body is divided into two parts, an initial load of the spring 5 is arbitrarily adjusted by appropriately changing a position in which the first body 2 and the second body 3 are combined. As a result, selective use of the spring 5 or selective use of a shim for regulating a spring load is unnecessary. Thus, the piston valve 1 is more easily assembled.

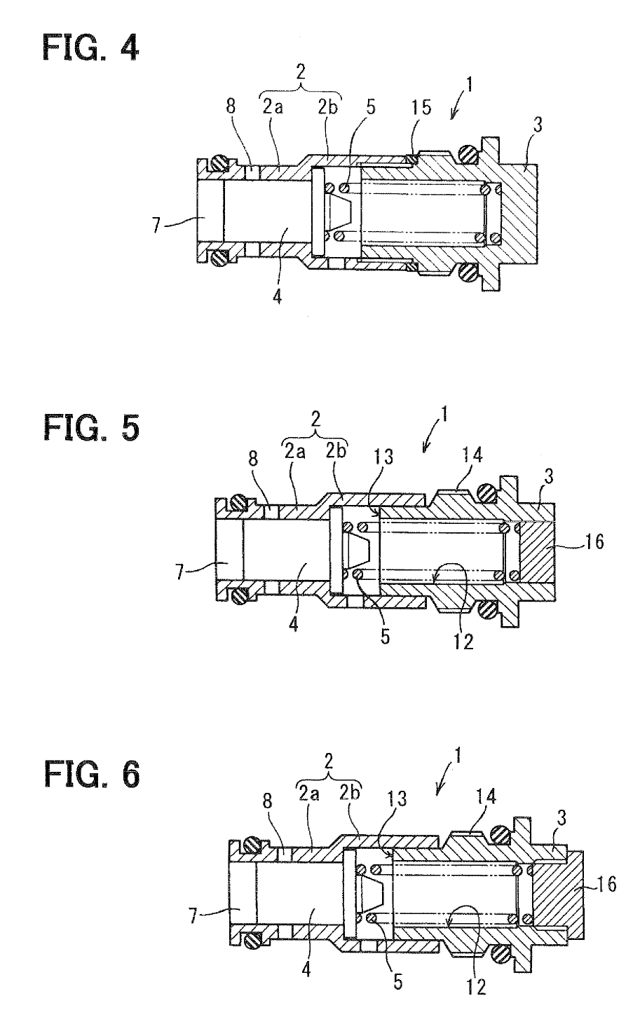

Any one of a) to d) may be employed for a method for fixing the first body 2 and the second body 3 together.
a) The one end side of the second body 3 is forcibly inserted into the inner circumferential surface of the large diameter cylindrical portion 2b of the first body 2.
b) As shown in (A) in FIG. 3, the first body 2 and the second body 3 are brazed together.
c) As shown in (B) in FIG. 3, the first body 2 and the second body 3 are welded together.
d) As shown in FIG. 4, the one end side of the second body 3 is screwed to the inner circumferential surface of the large diameter cylindrical portion 2b of the first body 2. By adjusting a relative position between the first body 2 and the second body 3 using a spacer 15, a desired spring load is obtained.

In the piston valve 1, when pressure of controlled fluid applied to a front surface of the piston 4 behaves anomalously, for example, when the pressure is abnormally high or repeatedly fluctuates sharply, an amplitude of the piston 4 becomes large. In the first embodiment, the second body 3 is provided with the stopper 13. Accordingly, when the piston 4 is displaced in the valve opening direction (e.g., when the pressure of controlled fluid applied to the front surface of the piston 4 abnormally rises), the flange portion 4a of the piston 4 collides with the stopper 13, and thereby the displacement of the piston 4 in the valve opening direction is restricted. As a result, the overshoot of the piston 4 is prevented, that is, the piston 4 is not displaced in the valve opening direction to the extent that the spring 5 is totally compressed. Consequently, permanent strain or breakage failure of the spring 5 is restricted. In addition, since the second body 3 is provided with the stopper 13, a conventional stopper pin (FIG. 14) is unnecessary.

When the piston 4 is displaced in the valve closing direction (e.g., when the pressure of controlled fluid applied to the front surface of the piston 4 decreases), the flange portion 4a of the piston 4 collides with the step formed on an inner circumferential surface of the first body 2 and thereby the displacement of the piston 4 in the valve closing direction is restricted. Because the step formed on the inner circumferential surface of the first body 2 is used as the valve closed side seating surface 9 of the piston 4, a bush (FIG. 12) in a conventional piston valve is unnecessary. Additionally, separation of the piston 4 and the spring 5 from the body is prevented without the bush.

As above, in the piston valve 1 of the first embodiment, parts such as the stopper pin, bush, and shim for regulating the spring load are unnecessary. Accordingly, compared to the conventional piston valve, in which these parts are used, cost reduction by reducing the number of parts is achieved

Since the bottom wall portion 3a, which blocks an end of the cylindrical hole 12 on its opposite-to the piston 4 side in a pocketed hole shape, is integrally provided to the second body 37 the end of the cylindrical hole 12 on its opposite-to the piston 4 side does not need to be blocked with a plug (FIG. 12). Accordingly, even when pressure of controlled fluid behaves anomalously, a problem that the plug falls out of the body is not caused, and thereby the piston valve 1 possesses higher reliability.

Furthermore, the piston valve 1 of the first embodiment is fixed to another object via the fixing portion 14, which is provided on the second body 3. Accordingly, even though the piston 4 is displaced in the valve opening direction to collide with the stopper 13, the second body 3 does not fall out of the first body 2 by the impact caused, and thereby reliability of the piston valve 1 is maintained.

In the piston valve 1 of the first embodiment, since the one end side of the second body 3 is inserted into the inner circumferential surface of the large diameter cylindrical portion 2b, an inner diameter of which is larger than the inner diameter of the sliding hole 6 formed in the piston sliding portion 2a of the first body 2, the inner diameter of the cylindrical hole 12 formed in the second body 3 is generally the same as the inner diameter of the sliding hole 6. In other words, even though the piston valve 1 is configured such that the second body 3 is inserted into the inner circumferential surface of the first body 2, decrease in the inner diameter of the cylindrical hole 12 formed in the second body 3 is restricted. Consequently, standards (particularly an outer diameter) of the spring 5, which is received in the cylindrical hole 12, may be made the same as an existing spring. As a result, the spring 5 urges a generally outer circumferential portion of the piston 4, so that an inclination of the piston 4 is restricted and the piston 4 is smoothly displaced.

In addition, since the outer diameter of the spring 5 is made large, safety against permanent strain or breakage failure of the spring 5 is easily ensured, and thereby a degree of flexibility in designing the piston valve 1 (selectable range of specifications such as valve opening pressure) becomes high.

When the outer diameter of the spring 5 is small, a generally inner circumferential portion of the piston 4 is urged, so that the piston 4 is more likely to be inclined when the piston 4 is displaced given a clearance between the piston 4 and the sliding hole 6 and thus the piston 4 may not be smoothly displaced. Also, when the outer diameter of the spring 5 is small, safety against permanent strain or breakage failure of the spring 5 is difficult to be ensured, so that a degree of flexibility in designing the piston valve 1 becomes low,

### Second Embodiment

In a piston valve 1 of a second embodiment of the present invention, as shown in FIG. 5, a cylindrical hole 12 formed in a second body 3 is a through hole, and an end of the through hole (cylindrical hole 12) on its opposite-to a piston 4 side is blocked with a plug 16.

The plug 16 may be fixed in the second body 3 to block the end of the through hole on its opposite-to the piston 4 side and to serve as a seating surface of a spring 5, by forcibly inserting the plug 16 into the through hole (FIG. 5) or by screwing the plug 16 into the through hole (FIG. 6).

In the above configuration in which the plug 16 is employed, an initial load of the spring 5 (the valve opening pressure of the piston valve 1) is easily adjusted by appropriately changing an attaching position (attaching depth) of the plug 16. As described in the first embodiment, the overshoot of the piston 4 is prevented by a stopper 13 (end face of the second body 3 on its one end side) provided to the second body 3, and thus it is not possible that the plug 16 falls out of the through hole.

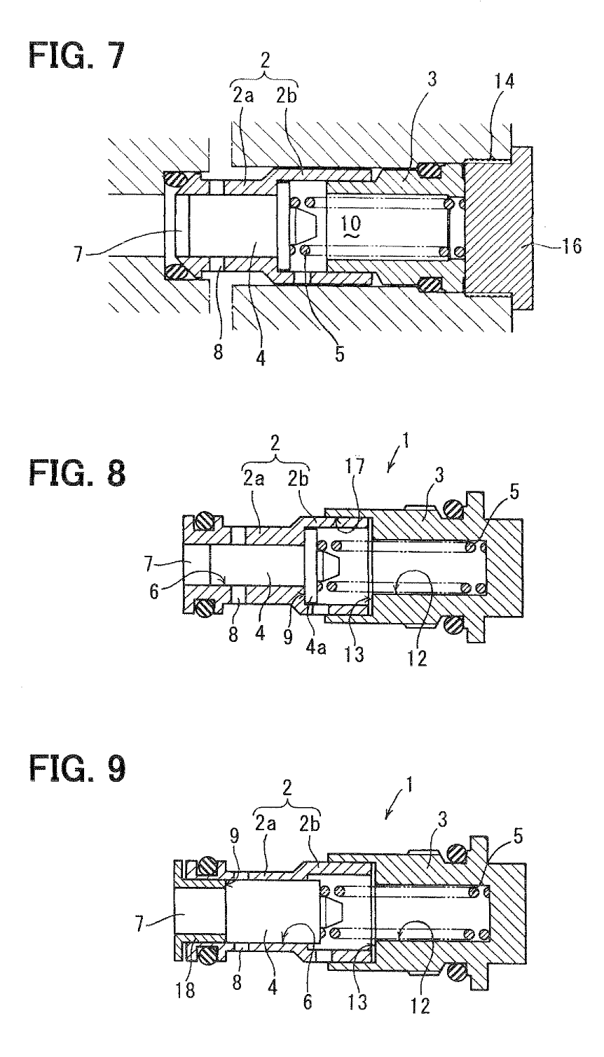

Similar to the first embodiment, the piston valve 1 in FIGS. 5, 6 is configured such that the piston valve 1 is fixed to another object using a fixing portion 14 (e.g., a male thread portion) formed on an outer circumferential surface of the second body 3 (FIG. 2). Alternatively, as shown in FIG. 7, the fixing portion 14, via which the piston valve 1 is fixed to another object, may be formed on the plug 16.

### Third Embodiment

As shown in FIG, 8, in a piston valve 1 of a third embodiment of the present invention, a body is configured by inserting a first body 2 into an inner circumferential surface of a second body 3.

Similar to the first embodiment, a large diameter cylindrical portion 2b, an inner diameter of which is larger than an inner diameter of a sliding hole 6 of a piston sliding portion 2a, is formed on an opposite-to an inlet 7 side of the first body 2 in its longitudinal direction. A step, which serves as a valve closed side seating surface 9 of a piston 4, is formed between an inner circumferential surface of the large diameter cylindrical portion 2b and an inner circumferential surface of the sliding hole 6.

As shown in FIG. 8, the second body 3 has a fitting hole 17, an inner diameter of which is larger than an inner diameter of a cylindrical hole 12, on one end side of the cylindrical hole 12. The second body 3 is combined with the first body 2 by inserting the large diameter cylindrical portion 2b of the first body 2 into an inner circumferential surface of the fitting hole 17. The second body 3 has a step, which serves as a stopper 13 for preventing the overshoot of the piston 4, between the inner circumferential surface of the fitting hole 17 and an inner circumferential surface of the cylindrical hole 12.

Similar to the first embodiment, the piston 4 has a flange portion 4a at an end portion of the piston 4 on its back face side. When the piston 4 is displaced in the valve opening direction in which a relief hole 8 is opened, the flange portion 4a contacts the stopper 13, and thereby displacement of the piston 4 in the valve opening direction is restricted. When the piston 4 is displaced in the valve closing direction in which the relief hole 8 is closed, the flange portion 4a contacts the valve closed side seating surface 9, and thereby displacement of the piston 4 in the valve closing direction is restricted.

Because the step formed in the first body 2 is used as the valve closed side seating surface 9 of the piston 4, the bush 150 (FIG. 12) described in the above related art is unnecessary. Furthermore, separation of the piston 4 and the spring 5 from the body is prevented without the bush 150.

According to the above configuration, since the first body 2 is inserted into an inner circumferential surface of the second body 3, an inner diameter of the cylindrical hole 12 formed in the second body 3 is generally the same as an inner diameter of the sliding hole 6. Accordingly, decrease in the inner diameter of the cylindrical hole 12 is restricted, so that standards (particularly an outer diameter) of the spring 5, which is received in the cylindrical hole 12, can be made the same as an existing spring.

When the outer diameter of the spring 5 is small, a generally inner circumferential portion of the piston 4 is urged, so that the piston 4 is more likely to be inclined when the piston 4 is displaced given a clearance between the piston 4 and the sliding hole 6 and thus the piston 4 may not be smoothly displaced. Also, when the outer diameter of the spring 5 is small, safety against permanent strain or breakage failure of the spring 5 is difficult to ensure, so that a degree of flexibility in designing the piston valve 1 becomes low.

When the outer diameter of the spring 5 is large, the spring 5 urges a generally outer circumferential portion of the piston 4, so that an inclination of the piston 4 is restricted and the piston 4 is smoothly displaced. Moreover, safety against permanent strain or breakage failure of the spring 5 is easy to ensure, so that a degree of flexibility in designing the piston valve 1 becomes high.

In the above configuration of the third embodiment as well, similar to the piston valve I of the first embodiment, cost reduction by reducing the number of parts is achieved and reliability is improved.

### Fourth Embodiment

As shown in FIG. 9, in a piston valve 1 of a fourth embodiment of the present invention, a bush 18 is attached to an opening of a piston sliding portion 2a of a first body 2 on one end side of the piston sliding portion 2a.

A configuration, in which a body is divided into the first body 2 and a second body 3 and a stopper 13 for preventing the overshoot of a piston 4 is formed in the second body 3, is the same as the first embodiment.

The bush 18 is forcibly inserted into an inner circumferential surface of a sliding hole 6 formed in the piston sliding portion 2a, to define an inlet 7 through which controlled fluid flows in and to serve as a valve closed side seating surface 9 of the piston 4.

When the piston 4 is displaced in the valve closing direction in which a relief hole 8 is closed, an outer circumferential area of a front surface of the piston 4 contacts an end face of the bush 18, which serves as the valve closed side seating surface 91 and thereby displacement of the piston 4 in the valve closing direction is restricted.

In the above configuration, since separation of the piston 4 and a spring 5 is prevented by the bush 18 (the piston 4 and spring 5 do not fall out of the sliding hole 6), which defines the inlet 7, the piston 4 does not need to be provided with a flange portion 4a (FIG. 1), so that the piston 4 having the same shape as an existing piston can be used.

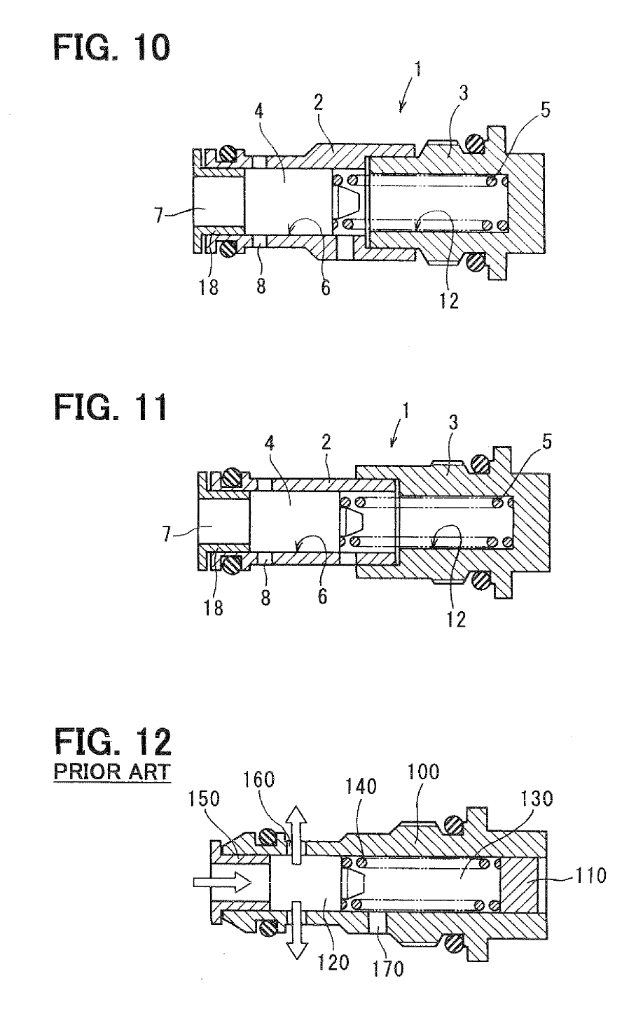

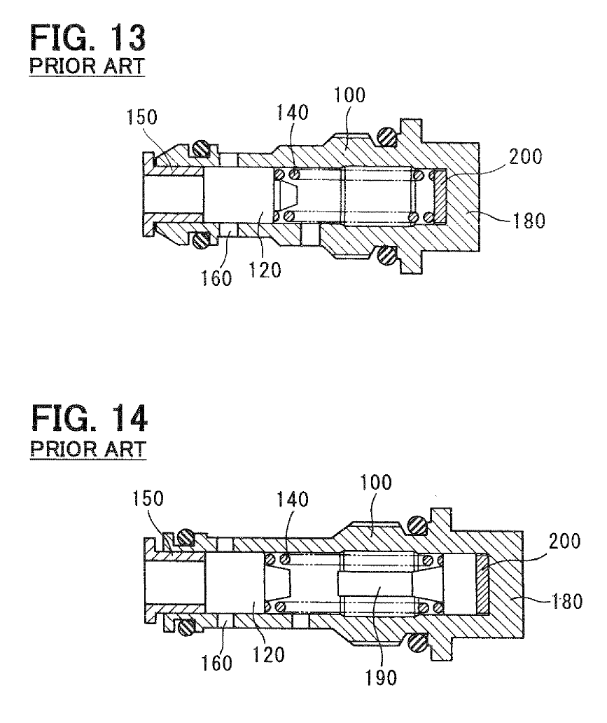

In addition to the configuration shown in FIG. 9, the piston valve 1 may have configurations shown in FIG. 10 or FIG. 11.

Additional advantages and modifications will readily occur to those skilled in the art. The invention in its broader terms is therefore not limited to the specific details, representative apparatus, and illustrative examples shown and described.

What is claimed is:

1. A piston valve comprising:
a body having an inlet on one end side of the body in a longitudinal direction of the body, wherein controlled fluid flows into the body through the inlet;
a relief hole that opens on a sidewall of the body, wherein controlled fluid in the body is discharged through the relief hole;
a piston that is slidably inserted in the body;
a damper chamber formed in the body, wherein the piston is located between the inlet and the damper chamber in the longitudinal direction; and
a spring that is disposed in the damper chamber and urges the piston in a direction toward the inlet, wherein:
an opening area of the relief hole is varied according to a position of the piston, in which the piston is balanced when pressure of controlled fluid applied to an inlet side-surface of the piston is equal to a sum of internal pressure of the damper chamber and reaction force of the spring, the sum being applied to a damper chamber side-surface of the piston;
the body is divided into a first body and a second body;
the first body has a cylindrical shape and opens at both ends of the first body;
the piston is slidably held in a piston sliding hole, which is formed on an inner circumferential side of the first body;
the second body is combined with the first body such that the second body is joined to a portion of the first body located on an opposite side of the inlet; and
the second body has a cylindrical hole, which defines the damper chamber in the body when the second body is combined with the first body.

2. The piston valve according to claim 1, wherein:
the second body is combined with the first body such that one end side of the second body in a longitudinal direction of the second body is inserted into an inner circumference of the first body located on the opposite side of the inlet;
the one end side of the second body has an end face, which serves as a stopper for preventing overshoot of the piston; and
when the piston is displaced in a valve opening direction in which the relief hole is opened, the piston contacts the stopper, so that the displacement of the piston in the valve opening direction is restricted.

3. The piston valve according to claim 2, wherein:
the first body has a large diameter cylindrical portion located on the opposite side of the inlet in a longitudinal direction of the first body;
the large diameter cylindrical portion has an inner diameter, which is larger than a diameter of the piston sliding hole, so that a step is formed between an inner circumferential surface of the piston sliding hole and an inner circumferential surface of the large diameter cylindrical portion;
the one end side of the second body in the longitudinal direction is inserted into an inner circumference of the large diameter cylindrical portion such that a predetermined distance is maintained between the step and the stopper in the longitudinal direction of the body;
the piston has a flange portion, which projects in a radially outward direction, at an end portion of the piston located on the opposite side of the inlet, and the flange portion is movable between the step and the stopper; and
when the piston is displaced in the valve opening direction, the flange portion contacts the stopper, so that the displacement of the piston in the valve opening direction is restricted.

4. The piston valve according to claim 3, wherein when the piston is displaced in a valve closing direction in which the relief hole is closed, the flange portion contacts the step, so that the displacement of the piston in the valve closing direction is restricted.

5. The piston valve according to claim 2, further comprising a cylindrical bush, which is attached to one opening of the first body thereby to define the inlet, wherein when the piston is displaced in a valve closing direction in which the relief hole is closed, the piston contacts an end face of the bush so that the displacement of the piston in the valve closing direction is restricted.

6. The piston valve according to claim 2, wherein the second body has a fixing portion, via which the body is fixed to another object, on an outer circumferential surface of the second body.

7. The piston valve according to claim 1, wherein:
the second body has a fitting hole on one end side of the cylindrical hole in a longitudinal direction of the second body;
the fitting hole has an inner diameter, which is larger than a diameter of the cylindrical hole, so that a first step, which serves as a stopper for preventing overshoot of the piston, is formed between an inner circumferential surface of the fitting hole and an inner circumferential surface of the cylindrical hole;
the second body is combined with the first body such that an end portion of the first body located on the opposite side of the inlet is inserted into an inner circumference of the fitting hole; and
when the piston is displaced in a valve opening direction in which the relief hole is opened, the piston contacts the stopper, so that the displacement of the piston in the valve opening direction is restricted.

8. The piston valve according to claim 7, wherein:
the first body has a large diameter cylindrical portion located on the opposite side of the inlet in a longitudinal direction of the first body;
the large diameter cylindrical portion has an inner diameter, which is larger than a diameter of the piston sliding hole, so that a second step is formed between an inner circumferential surface of the piston sliding hole and an inner circumferential surface of the large diameter cylindrical portion;
the large diameter cylindrical portion is inserted into the inner circumference of the fitting hole of the second body such that a predetermined distance is maintained between the second step and the stopper in the longitudinal direction of the body;
the piston has a flange portion, which projects in a radially outward direction, at an end portion of the piston located on the opposite side of the inlet, and the flange portion is movable between the second step and the stopper; and
when the piston is displaced in the valve opening direction, the flange portion contacts the stopper, so that the displacement of the piston in the valve opening direction is restricted.

9. The piston valve according to claim 8, wherein when the piston is displaced in a valve closing direction in which the relief hole is closed, the flange portion contacts the second step, so that the displacement of the piston in the valve closing direction is restricted.

10. The piston valve according to claim 7, further comprising a cylindrical bush, which is attached to one opening of the first body thereby to define the inlet, wherein when the piston is displaced in a valve closing direction in which the relief hole is closed, the piston contacts an end face of the bush, so that the displacement of the piston in the valve closing direction is restricted.

11. The piston valve according to claim 7, wherein the second body has a fixing portion, via which the body is fixed to another object, on an outer circumferential surface of the second body.

12. The piston valve according to claim 1, wherein the second body has a bottom wail portion, which is formed integrally with the second body and blocks in a blind hole shape an end of the cylindrical hole located on an opposite side of the piston in the longitudinal direction of the body.

13. The piston valve according to claim 1, wherein:
the cylindrical hole is a through hole, which penetrates through the second body; and
a plug is attached to the through hole to block an end of the through hole located on an opposite side of the piston in the longitudinal direction of the body.

14. The piston valve according to claim 1, wherein:
the piston valve is used in a fuel supply pump that pressurizes fuel, which is pumped up from a fuel tank using a feed pump, and that force-feeds the pressurized fuel into a common rail; and
the piston valve is used as a pressure-regulating valve that regulates discharge pressure of the feed pump.
